(19) United States
(12) Patent Application Publication
(10) Pub. No.: US 2025/0207619 A1
(43) Pub. Date: Jun. 26, 2025

(54) DEVICE FOR CONNECTING COMPONENTS AND ARRANGEMENT FOR COMPENSATING TOLERANCES

(71) Applicant: Witte Automotive GmbH, Velbert (DE)

(72) Inventor: Jan Christian BENTE, Sprockhövel (DE)

(21) Appl. No.: 18/989,600

(22) Filed: Dec. 20, 2024

(30) Foreign Application Priority Data
Dec. 21, 2023 (DE) 10 2023 213 153.6

(51) Int. Cl. F16B 5/02; F16B 37/12

(52) U.S. Cl. CPC F16B 5/025; F16B 37/127

(57) ABSTRACT

A device for compensating tolerances between two components to be interconnected may have at least one base element and a compensation element which is in or can be brought into threaded engagement. The base element may have a cavity having a number of first segments defining at least one thread turn and a number of second segments. The compensation element can be moved by a first rotary movement relative to the base element from a starting position into a compensating position and in the compensating position is in threaded engagement and/or frictional engagement and/or clamping engagement with the first segments and/or the second segments of the base element in order to receive a second rotary movement of a screw element.

### FIELD

The invention relates to a device for connecting components. The invention also relates to an arrangement for compensating tolerances between two components to be interconnected.

### BACKGROUND

Such a device is known in principle and is used, for example, in vehicle construction, in particular when two components are intended to be screwed together via a joint gap which is subject to tolerances. For this purpose, the device is placed between the components to be connected, and a screw element for screwing the components together, for example a screw or threaded bolt, is passed through correspondingly provided openings in the components and through the device. When screwing the screw element, the compensation element is rotated relative to the base element by means of a driving spring located between the screw element and the compensation element and is thus moved axially to the base element from its starting position, for example it is moved out of the base element until it reaches its compensating position, in which the base element and the compensation element each lie against one of the components and thus bridge the joint gap.

The object of the present invention is to provide a device which is improved compared with the prior art and is intended for compensating for tolerances between two components to be interconnected, and an arrangement for compensating for tolerances.

The object with regard to the device is achieved according to the invention by the indicated features of claim 1. The object with regard to the arrangement is achieved according to the invention by the indicated features of claim 14.

The object is achieved according to the invention with a device for connecting components, comprising at least one base element and a compensation element which is in or can be brought into threaded engagement, wherein the base element comprises a cavity having at least one thread turn and at least one clamping element.

### SUMMARY

In the present case, at least one thread turn can also be understood as a non-closed thread turn (also referred to as a thread turn segment), which can run in a helical shape of less than 360° on an inner wall of the cavity. Alternatively, a thread turn can also be understood as a closed thread turn which runs at least once or multiple times through 360° in a helical manner on an inner wall of the cavity.

Here the at least one thread turn can be segmented. In particular, the at least one thread turn can comprise a number of first segments, each forming a separate thread turn.

In addition, the at least one clamping element can be segmented. In particular, the at least one clamping element can comprise a number of second segments, each forming a separate clamping element. A number of first segments can also be understood as only one first segment. A number of second segments can also be understood as only one second segment.

In particular, the second segment(s) is/are designed as insulation displacement element(s). This allows for different connection portions between the base element and the compensation element. In particular, a first connecting portion between the base element and the compensation element can be designed as a threaded connection by means of the first segments and a second connecting portion can be designed as an insulation displacement connection by means of the second segments. In particular, the insulation displacement elements create an overlap with a thread of the compensation element. The invention is described below by way of example for a plurality of first segments and second segments.

This allows a play-free connection and an adjustment torque between the base element and the compensation element during pre-assembly and/or pre-fixing of both elements to one another. The clamping elements are preferably arranged between and/or below the first segment, designed as a thread turn segment or thread pitch segment. Alternatively, the clamping elements can also be arranged on the first segments or above them.

The compensation element can be moved from a starting position into a compensating position by twisting, in particular by a first assembly movement, in particular a rotary movement, relative to the base element. In particular in the compensating position, the compensation element can be in threaded engagement with the thread turn, in particular with the first segments, and/or in a frictional engagement and/or in a clamping engagement with the clamping element, in particular with the second segments, of the base element. In particular, the compensation element is in threaded engagement with the thread turn or with the first segments and/or in frictional engagement and/or in clamping engagement with the clamping element or with the second segments in order to receive a second assembly movement, in particular a second rotary movement, of a screw element connecting the two components in an associated cavity of the compensation element.

The advantages achieved with the invention consist in particular in the fact that a play-free thread, in particular a play-free threaded engagement, can be achieved. By means of the at least one thread turn and the at least one clamping element, in particular an insulation displacement element, a sufficient torque can be generated in a simple manner.

Because the cavity of the base element comprises at least one first segment defining a thread turn and at least one second segment generating a frictional torque and/or clamping torque, the compensation element can be in a play-free, in particular a clamping, engagement and/or in a frictional engagement with the base element, at least in the compensating position. A play-free and additionally clamping connection can be easily achieved by the interaction of an external thread of the compensation element with the first segment and with the second segment.

The segments can form an easy-to-manufacture and integrated nut thread. By using segments in the cavity of the base element, the base element and segments are designed to be demoldable. The base element thus comprises, by means of the first segments, a thread which can be easily demolded and, by means of the second segments, friction elements and/or clamping elements which can be easily demolded. After the base element has been manufactured, the finished base element can be removed from a manufacturing mold without breaking or damaging the manufacturing mold.

Easy demoldability is understood in particular to mean that two mold halves without a rotating core or folding core can produce a thread or thread turns on the base element and/or compensation element without undercuts in an injection molding process. The first segments, designed as thread segments, are arranged offset from one another so that undercuts can be avoided. In contrast, conventional multi-start threads always have undercuts.

The number of first segments and the number of second segments may vary. In particular, they can have different shapes and/or dimensions. The first segments and the second segments can be formed separately, in particular as separate mold segments or mold portions on the inner wall of the base element.

Alternatively, the first segments and the second segments, in particular pairs of first segments and second segments, can be formed in one piece. For example, the first segments and the second segments can be formed as a mold portion or as a mold segment on the inner wall of the base element.

The device having a plurality of first segments and a plurality of second segments is described below.

Engagement between the base element and compensation element which has no play, or at least reduced play and/or is self-locking, is understood in particular to mean a form-fitting and/or force-fitting connection, in particular a threaded engagement and/or a clamping and/or a wedging and/or an insulation displacement connection, of the two elements, such that they are rigidly connected to one another and are immovable, in particular are blocked against rotating relative to one another.

The first segment, which defines the thread turn, allows the compensation element to be rotated relative to the base element. A plurality of thread turns can be segmented and arranged offset from one another in the cavity of the base element. This allows the thread turn(s) in the base element to be demolded without any undercuts.

Due to the second segment, the compensation element in the compensating position can be in frictional engagement and/or in clamping engagement with the base element for tightening a screw element.

The compensation element can form a thread in the second segment, for example by cutting and/or grooving. Before fixing the two components to be connected, the compensation element can be brought into a corresponding compensating position by means of the first segments, in which position the compensation element is in or is brought into frictional engagement and/or clamping engagement with the base element in order to subsequently allow a screw element to be tightened to connect the two components. The compensation element can be pre-assembled in the base element and can be brought into the corresponding compensating position before the screw element for connecting the two components is inserted and can be pre-fixed in this compensating position.

The base element can be formed integrally with one of the components. The base element can, for example, already be present as a suitable component and/or as a customer interface. The corresponding component or the customer interface can be easily demolded using the segments.

The device can, for example, be a tolerance compensation device which can be brought to a suitable height to bridge a gap, for example a joint gap, between the components to be connected before the components are fixed. For example, this can relate to components for mounting a tail light, a door handle, a headlight, or the like of a vehicle.

In other words: The base element with the compensation element arranged therein can be easily pre-assembled on one of the components, for example at a customer interface. The base element can optionally already be or form a component, for example a customer interface. The compensation element can be rotated relative to the base element to adjust the height of the compensation element relative to the base element.

The segment defining the thread turn can be present or formed as a bulge having a thread shape. The second segment can be present or designed as a clamping element protruding into the cavity. The compensation element, in particular its external thread, can be configured to groove, form, and/or cut into the second segment, in particular to form or cut a thread into the second segment. The demoldable second segment can be designed as a bulge, convexity, raised part, or the like.

The external thread of the compensation element can be in threaded engagement with the first segments. The external thread of the compensation element can be in frictional engagement and/or in clamping engagement with the second segments. The first segments can differ from the second segments in their shape and/or dimensions. The first segments can extend in the radial direction and/or circumferential direction in portions along an inner circumference of the base element. The second segments can be, for example, block-shaped. The second segments can extend more in the axial direction than in the radial direction and/or circumferential direction along the inner circumference of the base element.

The first segments and the second segments can be arranged distributed over the inner circumference of the base element. In particular, each of the segments can be formed separately from one another and arranged at a distance from one another.

The first segments can each be arranged radially and/or spaced apart from one another around the inner circumference. The second segments can each be arranged radially and/or spaced apart from one another around the inner circumference. For example, the first segments and/or the second segments can each extend over a circular arc-shaped portion of the inner circumference and can be arranged at a distance from one another around the inner circumference. At least the first segments can additionally or alternatively be arranged axially offset from one another.

At least one of the first segments and one of the second segments can be integrally formed. The second segment can differ from the first segment at least in its shape and/or dimensions. The second segment can be part of the first segment and can cause contact with the flank and/or outer surface and/or core diameter of the screw element due to a different thread shape and/or pitch. The external thread of the compensation element must form and/or cut into these segment portions of the integral second segments.

The second segments can be arranged in the axial direction, in particular in the assembly direction or screwing direction of the screw element, below and/or in the radial direction and/or in the circumferential direction adjacent, in particular laterally, to the first segments. For example, each first segment can be assigned a second segment. The external thread, for example a thread crest of the compensation element, must form and/or cut into these second segments. As a result, friction, in particular a frictional torque, and/or a clamping and/or an insulation displacement, in particular a clamping torque, and additionally freedom from play can be produced.

The compensation element can have at least one drive contour, for example an external drive contour and/or internal drive contour, by which the compensation element can be moved from the base element into the corresponding compensating position before the screw element is inserted and before the components to be connected are fixed.

Furthermore, the invention relates to an arrangement for compensating tolerances between two components to be interconnected, wherein the arrangement comprises the previously described device having the base element having different segments, wherein the base element can on the one hand represent a separate part or can be integrated into one of the two components.

### DESCRIPTION OF THE FIGURES

Exemplary embodiments of the invention are explained in greater detail with reference to the drawings. In the figures:

FIG. 1 schematically shows, in an exploded view, a device for connecting components, in particular for compensating tolerances between two components to be interconnected,

FIGS. 2 to 4 schematically show a connection sequence for connecting two components by means of the device according to FIG. 1,

FIGS. 5 to 10 schematically show different perspective views and sectional representations of a base element of a device for compensating tolerances between two components to be interconnected,

FIGS. 11 to 13 schematically show different perspective views and a sectional representation of another base element of a device for compensating tolerances between two components to be interconnected,

FIGS. 14 and 15 schematically show different perspective views of a further base element of a device for compensating tolerances between two components to be interconnected,

FIG. 16 schematically shows a perspective view of a further base element of a device for compensating tolerances between two components to be interconnected,

FIG. 17 schematically shows a sectional view of a compensation element of a device for compensating tolerances between two components to be interconnected,

FIG. 18 schematically shows a perspective view of a further compensation element of a device for compensating tolerances between two components to be interconnected,

FIG. 19 schematically shows, in a perspective representation, another base element with a single thread turn and a plurality of clamping elements, and

FIG. 20 schematically shows a plan view of the base element according to FIG. 19.

### DETAILED DESCRIPTION

Parts corresponding to one another are provided with the same reference signs in all the drawings.

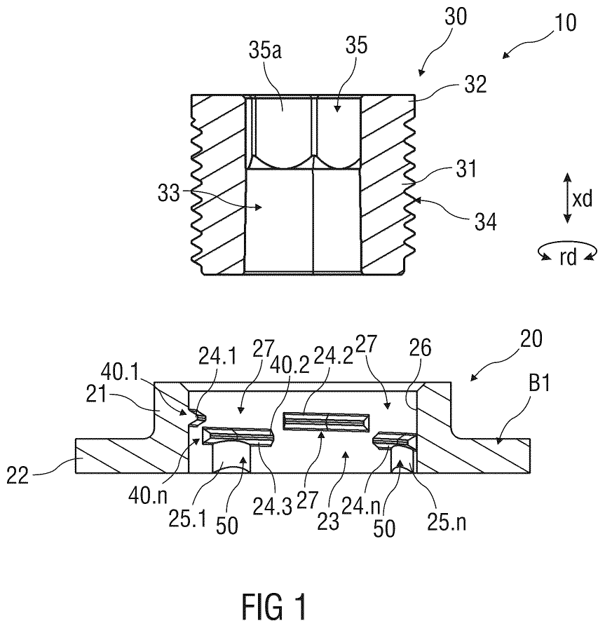

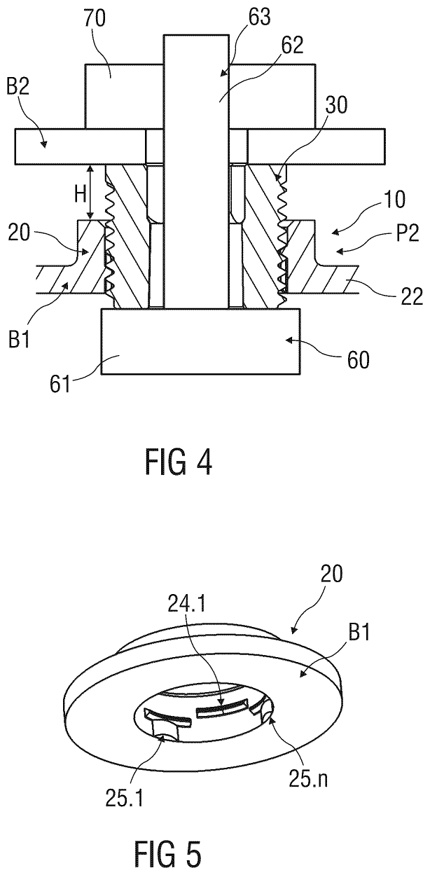

FIG. 1 shows schematically, in an exploded view, a device 10 according to the invention for compensating tolerances between two components B1, B2 (shown in FIG. 4) to be interconnected.

The device 10 is provided, for example, for attaching a first component B1, for example a bearing bracket, an electronic part, a lamp or a decorative part, to a second component B2, for example a door panel, a supporting structure or a body structure, of a vehicle. For example, the device 10 can be provided for connecting components in a vehicle interior, for example consoles, armrests and other vehicle components.

The device 10 comprises at least one base element 20, for example a hollow-cylindrical base element 20. The device 10 comprises at least one compensation element 30, for example a substantially hollow-cylindrical compensation element 30.

The base element 20 can be designed as a retaining element for holding the device 10 on a first component B1. For this purpose, the first component B1 can, for example, have a recess (not shown in detail).

The base element 20 according to the exemplary embodiment shown can already form one of the components B1, B2 (here designated as component B1). The base element 20 can be part of a customer interface. The base element 20 can be manufactured as a customer interface.

The base element 20 comprises at least one base body 21. A flange portion 22 can be provided on the end face of the base body 21. The flange portion 22 can be larger in diameter than the base body 21 and can form a bearing surface to be brought into contact with one of the components B1, B2. Alternatively, the base body 21 and flange portion 22 can already be present as a component B1, in particular as a customer interface, and/or be integrated into one of the two components B1, B2.

The base element 20 comprises a cavity 23 for receiving and holding the compensation element 30.

The cavity 23 comprises a number of first segments 24.1 to 24.n, which define at least one thread turn 40.1 to 40.n and are in particular demoldable. For example, a plurality of first segments 24.1, 24.2 can define a thread turn 40.1. For example, additional first segments 24.3, 24.n can define another thread turn 40.2, 40.n. The first segments 24.1 to 24.n of at least one of the thread turns 40.1, 40.2 are separated from one another or spaced from one another by interruptions 27 in the circumferential direction rd.

In the axial direction xd, the further first segments 24.3, 24.n of the second thread turn 40.2 are arranged offset from the first segments 24.1, 24.2 of the first thread turn 40.1. Below an interruption 27 (=distance) between two first segments 24.1, 24.2 of the first thread turn 40.1, a further first segment 24.3, 24.n of the second thread turn 40.2 can be arranged with an axial offset.

In particular, the first segments 24.1, 24.2 and the further first segments 24.3, 24.n are each distributed over an inner circumference 26 of the base element 20 and arranged at a distance from one another around the inner circumference 26.

The cavity 23 further comprises a number of, in particular demoldable, second segments 25.1 to 25.n. The second segments 25.1 to 25.n can be present in an initial state as clamping elements 50, in particular clamping points and/or clamping surfaces, and/or as friction elements, for example friction points and/or friction surfaces, and/or as insulation displacement elements.

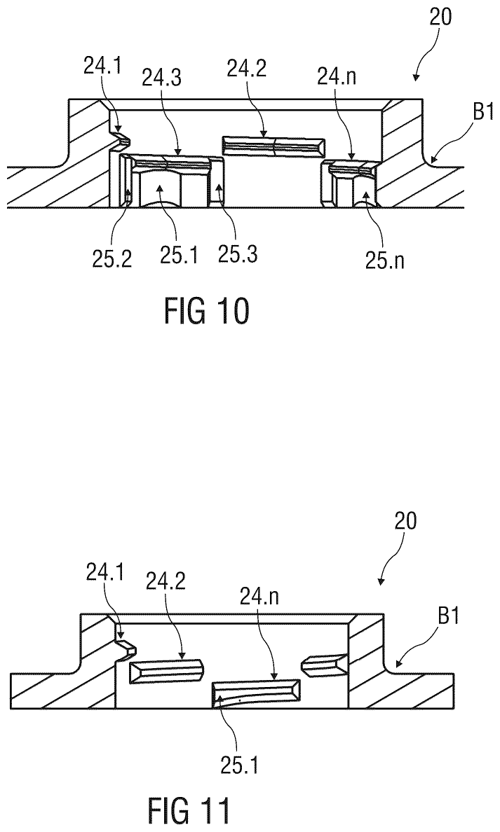

The second segments 25.1 to 25.n are designed, for example, as protruding ribs, webs, bulges, or the like. The second segments 25.1 to 25.n can, for example, be arranged or formed, in particular molded, below the first segments 24.1 to 24.n on the inner circumference 26 of the base element 20, as shown in FIG. 1. Additionally or alternatively, the second segments 25.1 to 25.n can be arranged or formed, in particular molded, laterally or next to the first segments 24.1 to 24.n on the inner circumference 26 of the base element 20, as shown in FIG. 10.

By rotating the compensation element 30, an external thread 34 of the compensation element 30 can come into or be brought into play-free frictional engagement and/or clamping engagement with the second segments 25.1 to 25.n and/or form, cut and/or groove a thread and/or a thread turn 40.1 to 40.n into the corresponding second segment 25.1 to 25.n, and can thus come into or be brought into an insulation displacement engagement.

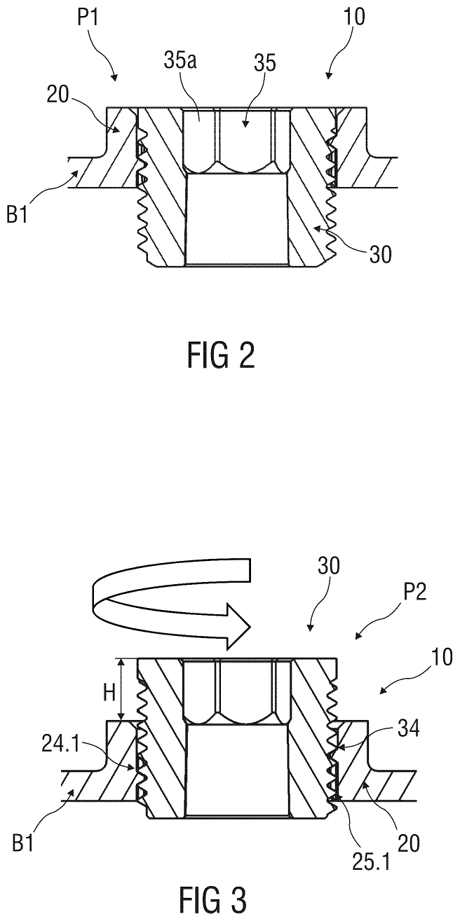

The compensation element 30 can be moved by rotation in the cavity 23 relative to the base element 20 from a starting position P1 (shown in FIG. 2) into a compensating position P2 (shown in FIGS. 3 and 4) and in the compensating position P2 can be in threaded engagement with the first segments 24.1 to 24.n and in frictional engagement and/or threaded engagement with the second segments 25.1 to 25.n. As a result, in the compensating position P2 the compensation element 30 can be configured to tighten a screw element 60 (shown in FIG. 4).

The first segments 24.1 to 24.n can form one thread turn 40.1 to 40.n or a plurality of thread turns 40.1 to 40.n. In addition, second segments 25.1 to 25.n can be provided on the inner circumference 26, into which the compensation element 30 engages, in particular forms and/or cuts.

A first thread turn 40.1, in particular a thread inlet, can have play. A clamping region formed by the second segments 25.1 to 25.n can come later or be arranged adjacent to or following the first segments 24.1 to 24.n in the axial direction xd. This makes it easier to find the first thread turn 40.1.

The base element 20 can be configured to form an easily demoldable and/or clamping and optionally additionally multi-start nut thread. The base element 20 can be manufactured in an “open-close” shape, in particular without undercuts.

The compensation element 30 comprises a base body 31 and a flange portion 32 arranged on the end face of the base body 31. The diameter of the flange portion 32 can be larger than or equal to the diameter of the base body 31, and the flange portion can form a bearing surface to be brought into contact with one of the components B1, B2.

The compensation element 30 further comprises an associated cavity 33. The associated cavity 33 can be designed without a thread, as in the exemplary embodiment shown. The compensation element 30 further comprises an external thread 34.

In the assembled state, for example pre-assembled state and/or delivery state, the compensation element 30 can already be arranged in the base element 20 (as shown in FIG. 2).

The compensation element 30 comprises at least one drive contour 35, by means of which the compensation element 30 can be moved from the base element 20 into the compensating position P2 before the components B1, B2 to be connected are fixed. By rotating the compensation element 30 on the drive contour 35, for example in the form of a drive interface, the compensation element 30 can be moved relative to the base element 20, in particular out of the base element 20. As a result, a desired height H to be occupied (shown in FIGS. 3 and 4) of the device 10 can be set to overcome a predetermined distance between the components B1, B2.

In the embodiment shown, the drive contour 35 is an internal drive contour 35a arranged or formed in the associated cavity 33. For example, the inner drive contour 35a can be arranged in the associated cavity 33 and/or formed by a recess or cutout formed in the flange portion 32 of the compensation element 30. A suitable tool can be insertable or inserted into the inner drive contour 35a. For example, the internal drive contour 35a can be designed as a hexagon socket or square socket, a slot or a crossed slot. A conventional drive tool (not shown in detail), for example in the form of a screwdriver, can be used.

FIGS. 2 to 4 schematically shows a connection sequence for connecting two components B1, B2 by means of the device 10 according to FIG. 1, wherein the base element 20 is integrated in a first component B1.

FIG. 2 shows the device 10 in a starting position P1 with a compensation element 30 arranged in the base element 20 or in the first component B1. The compensation element 30 is pre-assembled in the base element 20 or in the first component B1.

By rotating the compensation element 30 on the drive contour 35, in particular with the aid of a suitable drive tool, a height H of the device 10 can be adjusted to compensate tolerances, in particular a joint gap.

FIG. 3 shows the device 10 in a compensating position P2, wherein the compensation element 30 has been rotated out of the base element 20 relative to the latter in order to subsequently allow a screw element 60 to be tightened.

Once the compensating position P2 has been assumed, a second component B2 is placed on one end face of the compensation element 30 and connected to the first component B1.

In other words: if the compensation element 30 is at the desired height H relative to the base element 20, i.e. in the compensating position P2, the second component B2 can be fixed. In the compensating position P2, the compensation element 30 is in frictional engagement and/or threaded engagement with the second segments 25.1 to 25.n of the base element 20 through its external thread 34 for tightening the screw element 60.

The compensation element 30 is screwed to the second component B2 or to a second customer interface.

FIG. 4 shows the two components B1, B2 in the interconnected state. The screw element 60 can be tightened as a result of the frictional engagement and/or threaded engagement between the compensation element 30 and the base element 20.

The screw element 60 can comprise at least a head 61, for example a screw head, and a shaft 62. The shaft 62 can be provided with a thread 63 at least in portions of the circumference. In the final assembled state, the head 61 of the screw element 60 is supported on an end face of the compensation element 30 and/or on a surface side of the first component B1, for example on the flange portion 22 of the base element 20. At the other end of the screw element 60, that is, on a surface side of the second component B2, a nut 70 can be connected to the screw element 60.

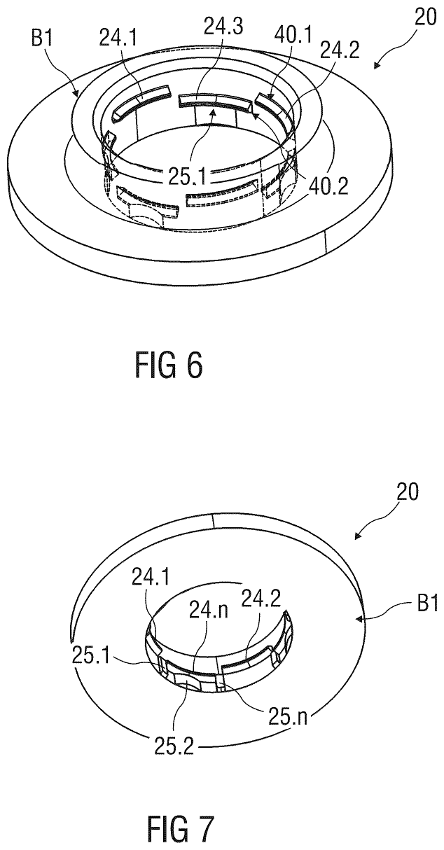

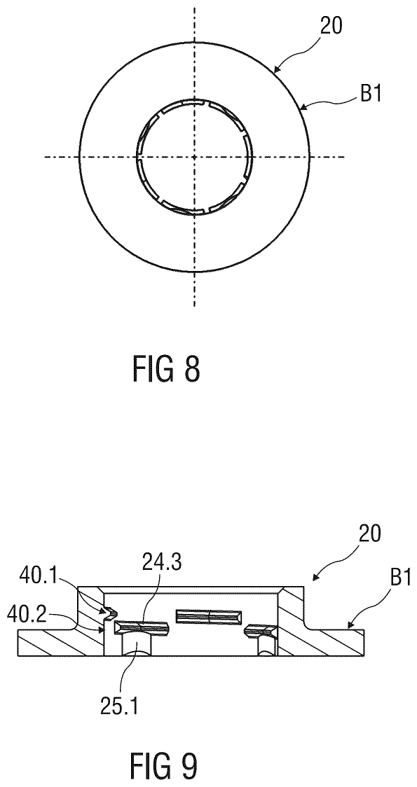

FIGS. 5 to 10 schematically show different perspective views and sectional representations of a base element 20 of a device 10 for compensating tolerances between two components B1, B2 to be interconnected.

The base element 20 can be formed integrally with one of the components B1, B2 (identified here as component B1 in each case).

The second segments 25.1 to 25.n can be located below and/or above and/or next to the first segments 24.1 to 24.n, for example thread segments and/or thread portions.

The first segments 24.1 to 24.n can be arranged radially and/or around the inner circumference 26 at a distance from one another and/or axially offset from one another in the base element 20. The second segments 25.1 to 25.n can be arranged radially and/or around the inner circumference 26 at a distance from one another and/or axially offset from one another in the base element 20.

Thread crests of the external thread 34 of the compensation element 30 must be configured to be able to form and/or cut into the second segments 25.1 to 25.n in order to create a clamping, in particular an insulation displacement connection, a freedom from play, and a clamping torque.

The second segments 25.1 to 25.n can, for example, be arranged below an uppermost first thread turn 40.1 and/or a second thread turn 40.2, which is defined by at least one first segment 24.1 to 24.n.

According to the exemplary embodiments according to FIGS. 5, 6, and 9, each first segment 24.1 to 24.n in the last or lowest second thread turn 40.2 can be assigned a second segment 25.1 to 25.n. In particular, the second segments 25.1 to 25.n are arranged below and/or adjacent to the last, i.e. lowest, first segments 24.1 to 24.n.

The base element 20 can have a plurality of differently designed second segments 25.1 to 25.n. The second segments 25.1 to 25.n can be arranged in the axial direction xd (shown in FIG. 1) below and/or in the circumferential direction rd adjacent to the first segments 24.1 to 24.n. Each first segment 24.1 to 24.n can be assigned at least one second segment 25.1 to 25.n. According to the exemplary embodiments of FIGS. 7 and 10, two or three second segments 25.1 to 25.n can be assigned to each lower first segment 24.1 to 24.n. Alternatively, the number of first segments 24.n can be greater than the number of second segments 25.n. In particular, only half as many second segments 25.n as first segments 24.n can be formed on the inner circumference 26.

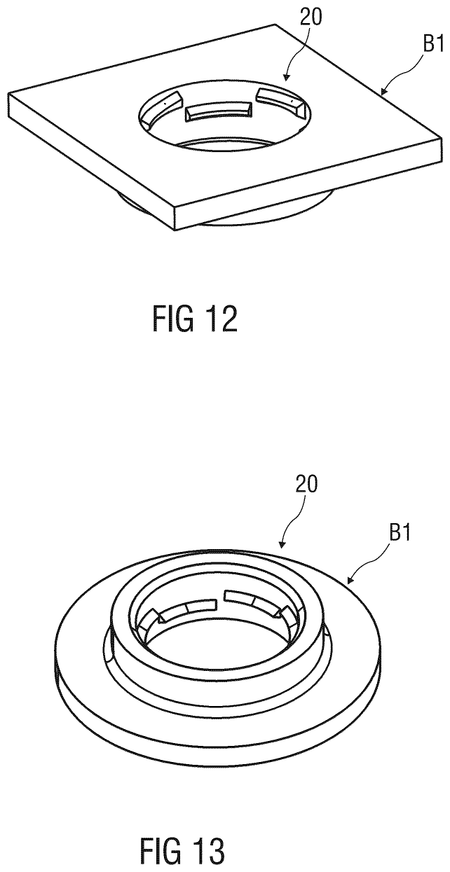

FIGS. 11 to 13 schematically show different perspective views and a sectional representation of a further base element 20 of a device 10 for compensating tolerances between two components B1, B2 to be interconnected.

The base element 20 can be formed integrally with one of the components B1, B2 (identified here as component B1 in each case).

The second segments 25.1 to 25.n can be part of the first segments 24.1 to 24.n and can cause contact at the flank and/or outer diameter and/or core diameter due to a different shape, for example thread shape and/or thread pitch. A thickness at the flank diameter of each of the second segments 25.1 to 25.n may be made “too large” in the initial state. A core diameter of each of the second segments 25.1 to 25.n may be “too small” and/or “too pointed.”

The external thread 34 of the compensation element 30 can form and/or cut into the second segments 25.1 to 25.n.

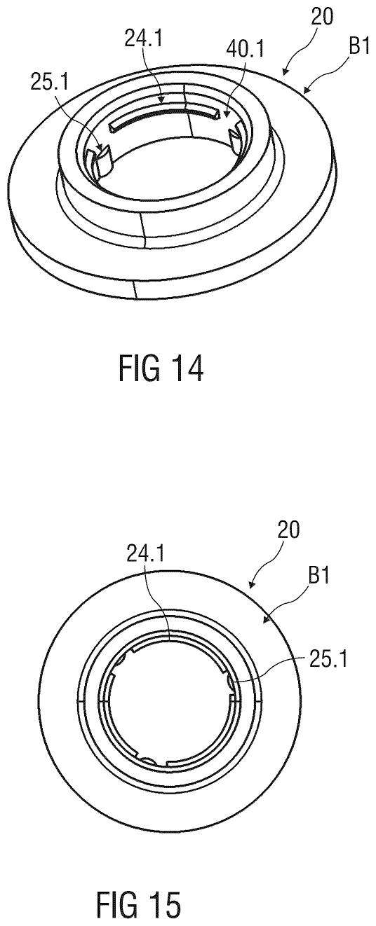

FIGS. 14 and 15 schematically show different perspective views of a further base element 20 of a device 10 for compensating tolerances between two components B1, B2 to be interconnected.

The base element 20 can be formed integrally with one of the components B1, B2 (identified here as component B1 in each case).

The base element 20 can have only one, the first, thread turn 40.1. For example, the base element 20 can comprise a first segment 24.1 defining the first thread turn 40.1 or a plurality of first segments 24.1 defining a common first thread turn 40.1. At least one second segment 25.1 can be arranged in the axial direction xd below (or above) the first segment 24.1 or the first segments 24.1 to 24.n.

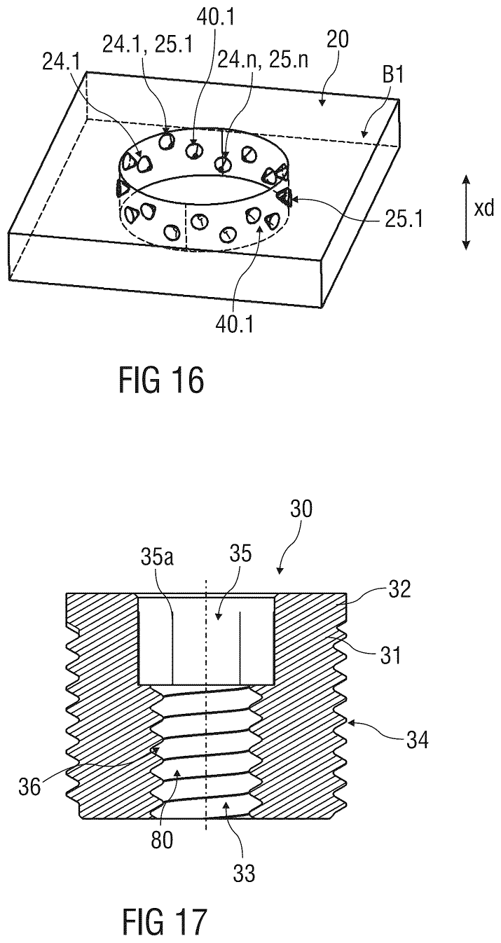

FIG. 16 schematically shows a perspective view of a further base element 20 of a device 10 for compensating for tolerances between two components B1, B2 to be interconnected.

The base element 20 can be formed integrally with one of the components B1, B2 (here designated as component B1).

The first segments 24.1 to 24.n and the second segments 25.1 to 25.n can each be designed as similar bulges which run to a point.

The first segments 24.n are arranged on the inner circumference 26 in such a way that they form first thread turns 40.1 in portions. Viewed in the axial direction xd, the lowest segment ring or the uppermost segment ring can form the second segments 25.n.

FIG. 17 schematically shows a perspective view of a compensation element 30 of a device 10 for compensating tolerances between two components B1, B2 to be interconnected.

The compensation element 30 can have an internal drive contour 35a, for example an internal adjustment element, and an integrated nut element 80, in particular in the form of an internal thread 36 formed in the associated cavity 33 of the compensation element 30. This eliminates the need for a separate nut 70 for fastening the screw element 60 (as shown in FIG. 4).

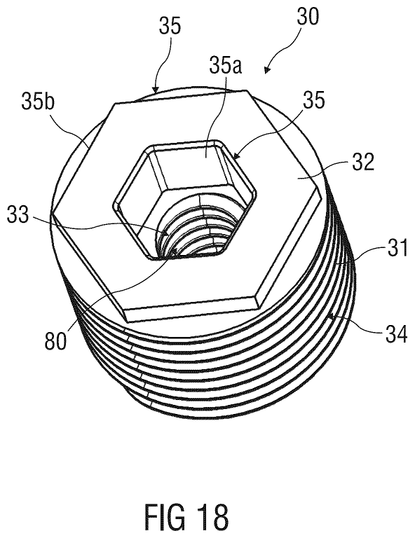

FIG. 18 schematically shows a perspective view of a further compensation element 30 of a device 10 for compensating tolerances between two components B1, B2 to be interconnected.

The compensation element 30 can have two drive contours 35 by means of which the compensation element 30 can be moved from the base element 20 into the compensating position P2 before the components B1, B2 to be connected are fixed. By rotating the compensation element 30 on at least one of the two drive contours 35, the compensation element 30 can be moved relative to the base element 20, in particular can be moved out of the base element 20.

The compensation element 30 can, for example, have an internal drive contour 35a. The compensation element 30 can, for example, alternatively or optionally additionally have an external drive contour 35b.

For example, the external drive contour 35b can be formed by the flange portion 32 of the compensation element 30, wherein the flange portion 32 can have an external circumference provided with corners and edges. The external drive contour 35b can be gripped by a suitable tool. The external drive contour 35b can be designed as a hexagonal drive or a square drive. A conventional drive tool, for example in the form of a wrench, can be used.

For example, the internal drive contour 35a can be formed by a recess or cutout formed in the flange portion 32 and/or in the base body 31 of the compensation element 30, into which recess or cutout a suitable tool can be inserted. For example, the internal drive contour 35a can be designed as a hexagon socket or square socket, a slot or a crossed slot. A conventional drive tool (not shown in detail), for example in the form of a screwdriver, can be used.

The external drive contour 35b is used in particular for the adjustment from the starting position P1 to the compensating position P2 and for the pre-fixing of the base element 20 and the compensation element 30 by means of the insulation displacement connection produced when moving into the compensating position P2.

The inner drive contour 35a is used in particular to connect the two components B1, B2 when screwing in the screw element 60 (shown in FIG. 4).

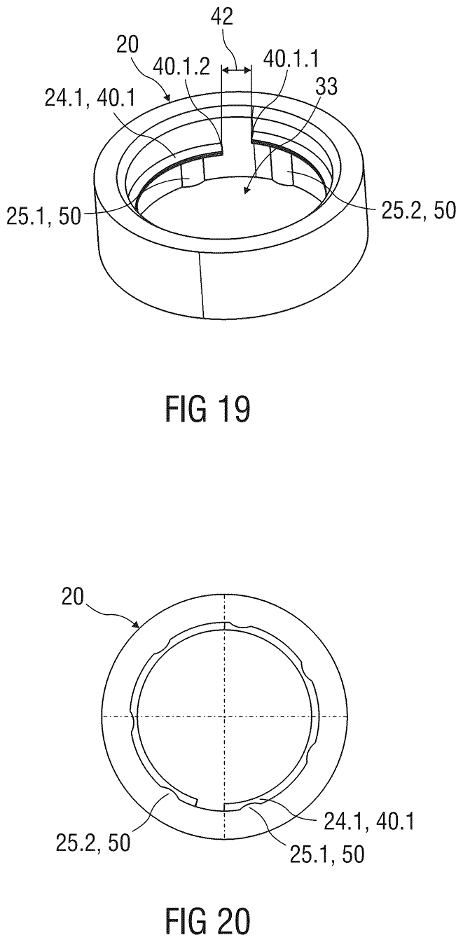

FIG. 19 schematically shows, in a perspective view, another base element 20 with a single thread turn 40.1 (=a first segment 24.1) which extends over less than 360° in a helical manner on an inner wall in the associated cavity 33 of the base element 20. In other words: the thread turn 40.1 is a non-closed thread turn (also referred to as a thread turn segment) which is smaller than 360°, so that a first thread turn end 40.1.1 is arranged at a distance 42 from a second thread turn end 40.1.2.

In addition, at least two clamping elements 50 are provided as second segments 25.1, 25.2 on the inner wall in the associated cavity 33. The clamping elements 50 extend axially from an end wall of the hollow-cylindrical base element 20 in the direction of the one thread turn 40.1. As a result, the clamping elements 50 have different axial heights.

FIG. 20 shows a schematic plan view from below of the base element 20 according to FIG. 19 with the single thread turn 40.1 as the first segment 24.1, the free ends of which are spaced apart from one another, and the plurality of clamping elements 50 as second segments 25.1, 25.2.

### LIST OF REFERENCE SIGNS

10 Device
20 Base element
21 Base body
22 Flange portion
23 Cavity
24.1 to 24.n First segment
25.1 to 25.n Second segment
26 Inner circumference
27 Interruption
30 Compensation element
31 Base body
32 Flange portion
33 Associated cavity
34 External thread
35 Drive contour
35a Internal drive contour
35b External drive contour
36 Internal thread
40.1 to 40.n Thread turn
40.1.1 First thread turn end
40.1.2 Second thread turn end
42 Distance
50 Clamping element
60 Screw element
61 Head
62 Shaft
63 Thread
70 Nut
80 Nut element
B1, B2 Component
H Height
P1 Starting position
P2 Compensating position
rd Circumferential direction
xd Axial direction

What is claimed is:

1. A device for connecting components, comprising at least one base element and a compensation element which is in threaded engagement, wherein the base element comprises a cavity having at least one thread turn and at least one clamping element.

2. The device according to claim 1, wherein the at least one clamping element is designed as an insulation displacement element.

3. The device according to claim 1, wherein the at least one thread turn comprises a number of first segments and/or the at least one clamping element comprises a number of second segments.

4. The device according to claim 1, wherein the compensation element can be moved by a first assembly movement, comprising a rotary movement, relative to the base element from a starting position into a compensating position and in the compensating position is in threaded engagement with the thread turn and/or in a frictional engagement and/or a clamping engagement with the clamping element of the base element in order to receive a second assembly movement, comprising a rotary movement, of a screw element in an associated cavity of the compensation element.

5. The device according to claim 4, wherein an external thread of the compensation element is in threaded engagement with the thread turn and in frictional engagement and/or in clamping engagement with the clamping element, wherein the external thread forms and/or cuts into the clamping element.

6. The device according to claim 3, wherein the first segments and the second segments are arranged distributed over an inner circumference of the base element.

7. The device according to claim 3, wherein a plurality of first segments are arranged spaced apart from one another around the inner circumference and the second segments are arranged spaced apart from one another around the inner circumference.

8. The device according to claim 3, wherein at least the first segments are arranged axially offset from one another.

9. The device according to claim 3, wherein a plurality of second segments are arranged in the axial direction below or above the first segments and/or in the circumferential direction laterally to the first segments.

10. The device according to claim 3, wherein at least a first segment and a second segment are integrally formed.

11. The device according to claim 3, wherein the second segment differs at least in its shape and/or dimensions from the first segment.

12. The device according to claim 1, wherein the base element and one of the components are integrally formed.

13. The device according to claim 1, wherein the compensation element has at least one drive contour by means of which the compensation element can be moved from the base element into the compensating position before a screw element is introduced and before the components to be connected are fixed.

14. An arrangement for compensating tolerances between two components to be interconnected, comprising two components and at least one device according to claim 1.
